(19) United States
(12) Patent Application Publication
(10) Pub. No.: US 2005/0278893 A1
(43) Pub. Date: Dec. 22, 2005

(54) Curtain hook, and strip and carriage for use in such a curtain hook

(75) Inventor: Jeroen Petrus Theodorus Maria Abelen, Rosmalen (NL)

Correspondence Address: THE WEBB LAW FIRM, P.C., 700 KOPPERS BUILDING, 436 SEVENTH AVENUE, PITTSBURGH, PA, 15219, US

(73) Assignee: WYBENGA MACHINES B.V., Enschede (NL)

(21) Appl. No.: 11/149,934

(22) Filed: Jun. 10, 2005

(30) Foreign Application Priority Data
Jun. 11, 2004 (NL) 1026404

(51) Int. Cl. E05D 15/00

(52) U.S. Cl. 16/87.2

(57) ABSTRACT

The invention relates to a curtain hook, comprising: a strip, an assembly connected to the strip of a first flange directed toward the strip and a second flange directed away from the strip, and at least one carriage closing round the second flange and provided with a hook-like member, wherein the carriage is displaceable relative to the second flange. The invention also relates to a strip for use in such a curtain hook. The invention further relates to a carriage for use in such a curtain hook.

The invention relates to a curtain hook, comprising: a strip, an assembly connected to the strip of a first flange directed toward the strip and a second flange directed away from the strip, and at least one carriage closing round the second flange and provided with a hook-like member, wherein the carriage is displaceable relative to the second flange. The invention also relates to a strip for use in such a curtain hook. The invention further relates to a carriage for use in such a curtain hook.

The curtain hook mentioned in the preamble is already known. The Netherlands patent NL 9301873 for instance thus describes such a curtain hook, wherein a side of the first flange directed away from the strip is provided with a sawtooth profile adapted for co-action with a flexible lip forming part of the carriage. Because of the sawtooth profile the carriage is only displaceable in a single direction along the second flange. It has been found that the carriage is attached to the strip in relatively unreliable and weak manner, or at least to the second flange, which considerably limits the connection of the curtain hook into a curtain fold, as well as the use of the stitched curtain hook. The lifespan of the curtain hook per se is moreover relatively short as a result of the relatively weak, unstable coupling between the strip and the carriage via the second flange.

The invention has for its object to provide an improved curtain hook with which a relatively reliable coupling can be realized between the strip and the carriage.

The invention provides for this purpose a curtain hook of the type stated in the preamble, characterized in that the carriage is adapted to engage at least partly round the first flange. By having the carriage engage at least partly round the first flange in addition to closing round the second flange a relatively reliable, strong and therefore stable coupling can be obtained between the strip on the one hand and the carriage on the other. Such a relatively reliable, strong (releasable) coupling resulting from the multilateral stabilization facilitates connection and use of the curtain hook, since the curtain hook as a whole is structurally relatively robust compared to the known curtain hook. During use of the curtain hook according to the invention the tensile strength of the curtain hook as a result of the relatively reliable coupling between the strip and the carriage will decrease relatively slowly compared to the decrease in the tensile strength in conventional hooks. In addition to a greater flexibility in connection and application of the curtain hook according to the invention, the curtain hook will generally also have a relatively long lifespan. It is noted that the carriage and the strip, or at least the second flange connected to the strip, are coupled releasably to each other, whereby a reliable coupling between the two components determines the overall strength and robustness of the curtain hook.

In a preferred embodiment both the first flange and the second flange project on two sides relative to the strip, or at least relative to a plane defined by the strip. The two flanges and an intermediate part of the strip thus form together an I-profile adapted to enable stable guiding and support of the carriage. In a particular preferred embodiment, the first flange and the second flange project over substantially the same distance relative to a plane defined by the strip. A symmetrical I-profile is thus generated, using which the carriage can be coupled to the strip.

In another preferred embodiment, the first flange and/or the second flange is provided with at least one tooth-like profile adapted for co-action with a mating profile forming part of the carriage. It is possible here to envisage both flanges being provided with a tooth-like profile. The tooth-like profile is preferably formed by a sawtooth profile. At least a side of the second flange directed away from the strip is more preferably provided with the sawtooth profile. Such an outward directed positioning of the tooth-like profile will generally be advantageous, since such a positioning does not obstruct stitching of the curtain hook to a curtain fold. The mating profile is preferably formed by a flexible lip. It is possible here to envisage having a plurality of flexible lips engage on the same tooth-like profile. In the case a plurality of tooth-like profiles are applied which are for instance arranged on different flanges or on different sides of a particular flange, a corresponding number of lips can be applied in order to optimize the mutual co-action between the profiles and the mating profiles.

In a preferred embodiment, the carriage is adapted for multilateral engagement on the first flange. The carriage will generally at least engage on a side of the first flange directed toward the second flange. In order to optimize the mutual coupling of the strip and the carriage, the carriage will generally also engage on at least one side of the first flange, and not on a side of the first flange directed toward the second flange. Such an (end) surface will usually connect to the side of the first flange directed toward the second flange. It is however also possible to envisage the carriage at least partially engaging or closing round the first flange. The carriage then also engages on a side of the first flange directed away from the second flange. A multilateral engagement of the carriage on each of the first flange and the second flange will generally take place in each discussed variant.

In another preferred embodiment, the first flange and/or the second flange takes an at least partially angular cross-sectional form. The relevant flange will herein generally have a rectangular section, wherein the flange projects (perpendicularly) on one side, but preferably on two sides, relative to a plane defined by the strip. It is however also possible to envisage the first flange and/or the second flange taking an at least partially rounded cross-sectional form. The flange can herein also take a wholly rounded form. The advantage of such a rounding is that a curtain, during connection of the curtain hook by stitching the curtain hook to the curtain, will not be caught behind sharp, angular parts of the flange. In a particular preferred embodiment, the first flange has a rounded cross-sectional form on a side directed away from the second flange, i.e. the side along which stitching will be arranged, while a side directed toward the second flange has an angular cross-sectional form in order to prevent the first flange taking up space in undesirable manner.

A part of the strip connecting to the first flange preferably takes a thickened form. This thickened part preferably connects to a side of the first flange directed away from the second flange and functions particularly as strengthening for the curtain hook as a whole.

The first flange and the second flange are preferably each provided with at least one protrusion adapted for co-action with an external holding member for stabilized displacement of the curtain hook. The flanges are generally provided on one side close to an end longitudinal edge of the strip with a plurality of, in particular two, protrusions, wherein the protrusions of both flanges are directed toward each other. A feed member, usually formed by a jaw-like member, will generally close partially round a part of the strip lying between the two flanges, whereafter the curtain hook can be displaced mechanically in the direction of a stitch plate under a sewing machine.

In a preferred embodiment, the carriage is provided with a passage opening for the second flange, which passage opening is bounded by a plurality of engaging members adapted to engage over the second flange and for multilateral engagement on the first flange. A part of the carriage remote from the passage opening here particularly takes an at least partially rounded form. As already noted in the foregoing, such a rounding prevents undesired hooking of the curtain on a sharp, angular part of the curtain hook, whereby such a rounding will generally facilitate the connection, i.e. stitching, of the curtain hook into a curtain fold. p The invention also relates to a strip for use in such a curtain hook. The invention further relates to a carriage for use in such a curtain hook. Advantages of both parts of the curtain hook have already been described at length in the foregoing.

The invention will be elucidated on the basis of non-limitative exemplary embodiments shown in the following figures. Herein:

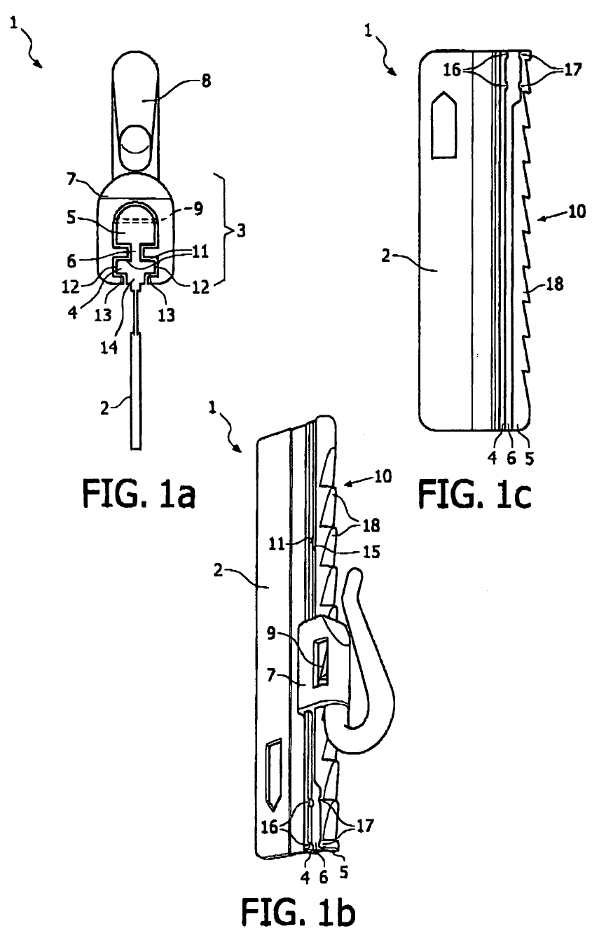

FIG. 1a shows a side view of a curtain hook according to the invention,

FIG. 1b shows a perspective view of the curtain hook of FIG. 1a,

FIG. 1c shows a top view of a part of the curtain hook of FIGS. 1aand 1b,

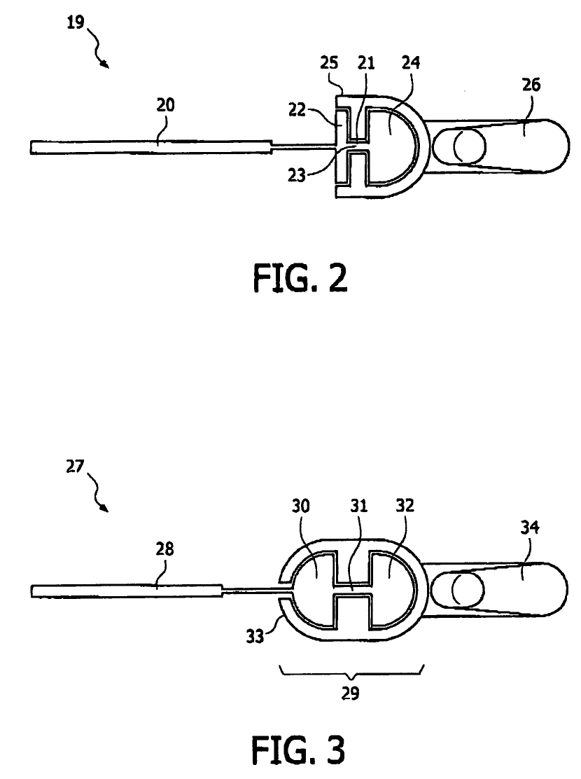

FIG. 2 shows a side view of another curtain hook according to the invention, and

FIG. 3 shows a side view of yet another curtain hook according to the invention

FIG. 1a shows a side view of a curtain hook 1 according to the invention. Curtain hook 1 comprises a strip 2 and an assembly 3 connected to strip 2 of a first flange 4 directed toward strip 2, a second flange 5 directed away from strip 2, and a body 6 for spacing apart the two flanges 4, 5. A carriage 7 provided with a hook-like body 8 substantially engages round assembly 3. Carriage 7 is also provided with a flexible lip 9 which now engages on a sawtooth profile 10 arranged on second flange 5 (see FIG. 1b). Carriage 7 engages on assembly 3 with clamp fitting such that displacement of carriage 7 relative to assembly 3 is possible in one direction. Since carriage 7 closes tightly round both flanges 4, 5, a reliable coupling between carriage 7 and strip 2 is realized, which results in a relatively robust curtain hook 1. Carriage 7 herein engages on a side 11 of first flange 4 directed toward the second flange as well as on two end surfaces 12 of first flange 4 which connect onto this side 11. Carriage 7 moreover engages on a part of a side 13 of first flange 4 directed away from second flange 5. In addition to a relatively long lifespan, such a relatively reliable and stable coupling has the advantage that handling of curtain hook 1 is facilitated, wherein the number of curtain hooks damaged during handling (and use) can be minimized. Strip 2 and assembly 3 are preferably constructed integrally from plastic, and manufactured in a single process step by means of injection moulding. During the injection moulding process a dye can be added to the curtain hook 1(to be manufactured). Curtain hook 1 preferably has at last one of the following colours: white, black, yellow, green, blue, red, purple, brown, orange, grey and pink. Strip 2 is provided adjacently of first flange 4 with a strengthening edge 14 for the purpose of providing additional strength. FIG. 1b shows a perspective view of curtain hook 1 of FIG. 1a. This figure shows clearly the sawtooth profile 10 which now co-acts with flexible lip 9 of carriage 7. FIG. 1b moreover shows that body 6 is given a widened form close to a longitudinal edge so that mechanical displacement can be facilitated. During such a displacement the curtain hook 1 is displaced by means of a jaw-like body (not shown), wherein the jaw-like body engages on two sides on a part of body 6. So as to be able to prevent (too) simple release of curtain hook 1 from the jaw-like body, the sides 11, 15 of the two flanges 4, 5 directed toward each other are each provided with two protrusions 16, 17 adapted to exert a certain bias on the jaw-like body. Such protrusions 16, 17 are also visualized in figure 1c, in which carriage 7 is not shown. Sawtooth profile 10 comprises a plurality of regularly ordered sawteeth 18, wherein each sawtooth 18 takes a truncated form on the longitudinal edges in order to be able to prevent undesired hooking of carriage 7 or of a curtain fold on sawteeth 18.

FIG. 2 shows a side view of another curtain hook 19 according to the invention. Curtain hook 19 comprises a strip 20 and an I-profile 21, connected to strip 20, of an inner flange 22, an intermediate part 23 and an outer flange 24. A carriage 25 provided with a hook-like member 26 engages round I-profile 21. Carriage 25 herein closes completely round outer flange 24, while inner flange 22 is engaged by carriage 25 on only three sides, i.e. a side directed toward the outer flange and two end surfaces. Clearly shown in FIG. 2 is that the inner flange 22 takes a rectangular cross-sectional form, wherein outer flange 24 takes a partly rounded cross-sectional form.

FIG. 3 shows a side view of yet another curtain hook 27 according to the invention. Structurally,the curtain hook 27 shown here greatly resembles the curtain hook 19 shown in FIG. 2. Curtain hook 27 also comprises a strip 28 and an I-profile 29, connected to strip 28, of an inner flange 30, a spacer 31 and an outer flange 32. A carriage 33 provided with a hook-like member 34 closes substantially round I-profile 29. In contrast to the curtain hook 19 shown in FIG. 2, inner flange 30 has a rounded cross-sectional form, wherein carriage 33 fits substantially closely against the rounded side of inner flange 30. In this configuration a reliable, stable releasable coupling can also be obtained between strip 28 on the one hand and carriage 33 on the other. It is noted that a tooth-like profile adapted for co-action with carriage 33 is not shown here. Such a profile can be arranged on inner flange 30 as well as on outer flange 32.

It will be apparent that the invention is not limited to the exemplary embodiments shown and described here, but that within the scope of the appended claims numerous variants are possible which will be self-evident to the skilled person in the field.

1-16. (canceled)

17. A curtain hook, comprising:
a strip,
an assembly connected to the strip of a first flange directed toward the strip and a second flange directed away from the strip, and
at least one carriage closing round the second flange and provided with a hook-like member, wherein the carriage is displaceable relative to the second flange,
wherein the carriage is adapted to engage at least partly round the first flange.

18. The curtain hook as claimed in claim 17, wherein the first flange and the second flange project on two sides relative to a plane defined by the strip.

19. The curtain hook as claimed in claim 17, wherein the first flange and the second flange project over substantially the same distance relative to a plane defined by the strip.

20. The curtain hook as claimed in claim 17, wherein the first flange and/or the second flange is provided with at least one tooth-like profile adapted for co-action with a mating profile forming part of the carriage.

21. The curtain hook as claimed in claim 20, wherein the tooth-like profile is formed by a sawtooth profile.

22. The curtain hook as claimed in claim 20, wherein a side of the second flange directed away from the strip is provided with the tooth-like profile.

23. The curtain hook as claimed in claim 20, wherein the mating profile is formed by a flexible lip.

24. The curtain hook as claimed in claim 17, wherein the carriage is adapted for multilateral engagement on the first flange.

25. The curtain hook as claimed in claim 17, wherein the first flange and/or the second flange has an at least partially angular cross-sectional form.

26. The curtain hook as claimed in claim 17, wherein the first flange and/or the second flange has an at least partially rounded cross-sectional form.

27. The curtain hook as claimed in claim 17, wherein a part of the strip connecting to the first flange takes a thickened form.

28. The curtain hook as claimed in claim 17, wherein the first flange and the second flange are each provided with at least one protrusion adapted for co-action with an external holding member for stabilized displacement of the curtain hook.

29. The curtain hook as claimed in claim 17, wherein the carriage is provided with a passage opening for the second flange, which passage opening is bounded by a plurality of engaging members adapted to engage over the second flange and for multilateral engagement on the first flange.

30. The curtain hook as claimed in claim 29, wherein a part of the carriage remote from the passage opening takes an at least partially rounded form.

31. A strip for use in a curtain hook as claimed in claim 17.

32. A carriage for use in a curtain hook as claimed in claim 17.
